(19) United States
(12) Patent Application Publication
(10) Pub. No.: US 2015/0251888 A1
(43) Pub. Date: Sep. 10, 2015

(54) Opening Device For Container Closures

(71) Applicant: ALLNOVATION B.V., Leidschendam (NL)

(72) Inventor: Gerardus Karel Maria Pelgrom, Zelhem (NL)

(73) Assignee: ALLNOVATION B.V., Zelhem (NL)

(21) Appl. No.: 14/433,248

(22) PCT Filed: Sep. 19, 2013
(86) PCT No.: PCT/NL2013/000044

§ 371 Date: Apr. 2, 2015

(30) Foreign Application Priority Data
Oct. 3, 2012 (NL) 1039836

(51) Int. Cl. B67B 7/44

(52) U.S. Cl. CPC B67B 7/44

(57) ABSTRACT

Device arranged for opening closures of various types of containers for food and/or stimulants. The device comprises a base body (1) with different opener modules (2-6). The enveloping shape (7) of the exterior shape of the base body is an ellipsoid, spheroid or sphere, by which ergonomic design the device is particularly suitable for older and weak users. The device may comprise opener modules (2, 3, 31) for opening screw caps, a can opener, modules (4, 5, 6) for opening of crown cork closures (16), turning lid closures, beverage cans (20), and an opener module for opening wine bottles, including an ergonomic handle (22) and a provision (28) to cut the end cap of the closure capsule before the cork is drawn from the bottle. The device may also include a multi-functional pedestal (29).

The invention relates to a device, which in particular is intended for opening closures of containers, in particular of consumer packaging for food and/or stimulants.

Containers for liquid and more or less solid food and/or stimulants include, for example:
cartons of coated paperboard, containing milk, yoghurt, wine, soft drinks, etc., with plastic screw caps; opening of the container is done by manually loosening the screw cap;
bottles of glass or plastic (e.g. PET), for containing beer, soft drinks, etc., provided with crown corks or screw caps; opening of the container is done by using a bottle-opener or manually by loosening the screw cap respectively;
glass jars, for containing pre-cooked vegetables, provided with clamping or turning lids; opening of the container is done by using a bottle-opener or by manually loosening of the turning lid respectively, preferably preceded by the use of a “lid-lifter” (it is noted that on the market there has recently appeared two-piece turning lids that can be opened more easily than the one-piece lids);
cans made of thin metal, typically aluminium, to contain soft drinks, beer, or more or less solid foods (such as corn, asparagus, etc.), provided with closures having a pull-tab; opening of the container is done by bending the pull-tab upwardly, whereupon the tab can be pushed further backwards and the associated tearing portion in the top of the can, in whole or in part, is torn away so that an opening is formed;
glass bottles, for containing wine, etc., provided with a cork or stopper of elastic material (“synthetic cork”), usually covered by a capsule of aluminium and/or plastic material; opening of the container is done by cutting loose the capsule and completely removing it, or by cutting loose the top “cap” of the capsule and then drawing the cork from the bottle with a corkscrew or a “sommelier knife” (combination of corkscrew and capsule knife).

The different containers must be opened on entirely different ways; some completely without auxiliary means, others by means of an aid (tools) such as: bottle-opener, lid-lifter, corkscrew, can opener or sommelier knife.

Apart from the necessity to use different tools to open the various container closures (when such are readily available), the problem often occurs that container closures, for which no aids are available, are often difficult to open. This problem is even more prominent with the elderly and the weaker: for example, loosening of the screw cap of a milk carton is often problematic for this category of users, as well as loosening the screw cap of a PET bottle.

Object of the present invention is therefore to provide for a device, which in particular is intended for—in an ergonomic way—opening closures of different types of containers, in particular of consumer packaging for food and/or stimulants, provided with rotating closures.

In particular, in view of its ergonomic properties, the device is specifically suitable for use by the elderly and the (muscle) weaker. It has been found that the ease of handling and ease of use of the device for this group of users—and therefore also for all users—is significantly better than with the openers known until now, because the enveloping shape of the principal shape of the exterior side of the base body is an ellipsoid, spheroid or sphere. A particular preference is the spherical shape.

An ellipsoid (see also http://en.wikipedia.org/wiki/Ellipsoid) is a quadratic surface with three perpendicular axes of symmetry. The relationship that describes an ellipsoid in the Cartesian coordinate system is:

$$\frac{{x}^{2}}{{a}^{2}} + \frac{{y}^{2}}{{b}^{2}} + \frac{{z}^{2}}{{c}^{2}} = 1$$

whereby a, b and c define the shape of the ellipsoid:
a≠b provides for an (scalene) ellipsoid;
b=c & a≠b & a≠c provides for a prolate (cigar-shaped) spheroid;
a=b & a≠c & a≠b provides for an oblate (pill-shaped) spheroid and
a=b=c provides for a sphere (ball). Each ellipsoid can be formed by “scaling” a ball (sphere) in one or two directions (along orthogonal axes).

According to the invention, the enveloping shape of the principal shape of the exterior side of the base (basic) body is a ball, ellipsoid, spheroid or sphere. It is not essential that the outer surface (exterior side) of the base body is completely smooth: this surface can also be formed by a large number of surfaces, or indentations or protuberances, for example, grooves, ridges, serrations, etc. so that, as is often applied to handles and hand grips etc., the grip on the outer surface of the base body is increased, because the outer surface of the base body is used as an ergonomically thoroughly designed actuating surface of the device, with which the various container closures can be manipulated. The actuating surface provides, thanks to the ellipsoid, spheroid or convex head shape, an excellent grip for the hand, even if that hand belongs to an older and/or weaker user of the device. In addition, the actuating surface is relatively large, so that the force exerted on the hands of the user is distributed over a larger surface area, as a result of which, with other words, the occurrence of local force and pressure “spots” are avoided.

The device preferably comprising one or more opener modules which are provided for and arranged for opening of a screw closure by rotation, each module comprising a cavity, suitable and arranged for engaging with its side plane the exterior side of the said screw closure. The cavity is preferably provided with a conical surface having a high friction resistance, for instance from rubber or an elastomer, and/or the cavity is provided with grooves, ridges, serrations etc.

The device is preferably provided with one or two opener modules, which are provided for and arranged for opening of container closures, which closures operate at least partly under the influence of a clamping force, such as a module for lifting of container closures that are provided with clamping edges, such as crown cork closures, or a module for screw closures secured by means of a clamping force such as turning lid closures etc.

The device is preferable also provided with an opener module provided for and arranged for lifting of the pull-tab of a container closure, which is provided with such a pull-tab.

If possible two or more opener modules are arranged in a common cavity on the exterior side of the base body. As a result, it is prevented that the (ergonomic) principal shape of the main body is substantially affected.

The device may also be provided with an opener module intended for and arranged for use as a can opener. The simplest form of a can opener consists of a specially shaped blade without moving parts. An indentation hooks behind the edge of the can and by means of leverage the lid is provided with a small incision. By moving the opener to the end of this incision it can be enlarged step by step, until the entire lid can be removed. Due to the ergonomic exterior shape of the present device this process is eased greatly and, in particular, is facilitated for the elderly and weak also.

Additionally, other embodiments of a can opener may be proposed for incorporation into the present device.

An alternative opener module is preferably provided with an opener module provided for and arranged for opening container closures that are provided with a cork or stopper, in particular for wine bottle closures. Any such opener module comprises preferably a sleeve extending through the base body, as well as a screw module bearing-mounted against or in the sleeve; the screw module being rotatable by means of a handle and being provided with a helical screw element, the screw module further being arranged to be able to insert the screw element from one side through the sleeve into the cork or stopper in order to remove the cork or stopper from the container (by rotation). Preferably the sleeve on its interior side is provided with one or more guide ridges that extend in the longitudinal direction of the sleeve for guiding of the cork or the stopper during its movement out of the container. In order to provide for an ergonomic actuation handle, by means of which the screw element is operated by the user, in other words, by means of which the screw element is pressed into the cork or stopper and rotated, and by means of which the cork or stopper is pulled out of the bottle, it is provided—as with the base body—that the enveloping shape of the principal shape of the exterior side of the handle of the screw module is a ball, ellipsoid, spheroid or sphere. Additionally, the exterior (outer) side may be provided with grooves, ribs, serrations etc. to increase the grip.

The sleeve is preferably arranged to partly enclose—at least with one end—the end cap of a closure capsule of a bottle, in particular of a wine bottle, and wherein the sleeve at that end is provided with—for example point or blade-shaped—means which are arranged to cut loose, by rotation of the sleeve and/or the base body, the end cap of the closure capsule, before the cork or stopper is moved out of the container.

It is noted that from US2006207390A1 a device is known for the opening of different closures. The device described therein is, among other things, arranged for opening screw caps of bottles. For that, the known device is provided with two gripping jaws movable towards each other against a spring force, in between which a screw cap can be clamped, and which subsequently is loosened or tightened.

In the device proposed by the present patent application, for loosening or tightening screw closures, use is being made of an engagement cavity that due to its shape and/or structure is suitable and is arranged for engaging the exterior (outer) side of the screw cap. This configuration is very simple with regard to the manufacturing technology and is also easier to operate than the known device. Furthermore, the enveloping shape of the principal (main) shape of the exterior side of the base body of the device according to the invention is a ball, ellipsoid, spheroid or sphere, which is not the case with the known device of US2006207390A1. Being provided with such a principal shape is considered to be of great importance for the invention, since this exterior shape is pre-eminently ergonomically suitable for the elderly and very (hand) weak.

Hereinafter, the invention will be discussed in some more detail by means of a few embodiments, with reference to some figures.

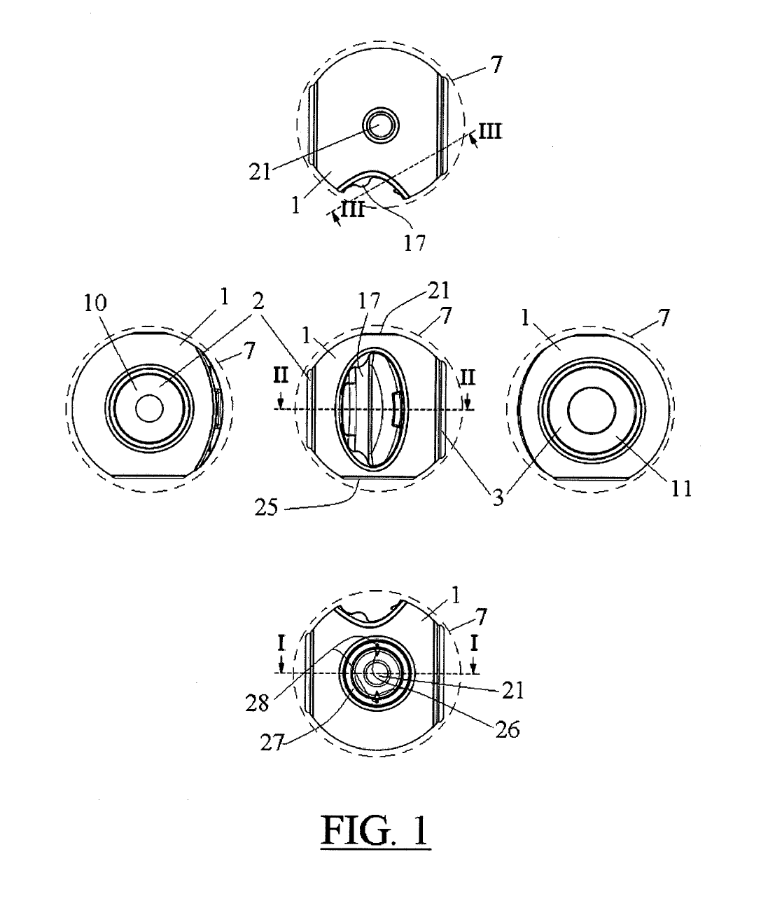

FIG. 1 shows a preferred embodiment of the base body in a number of views;

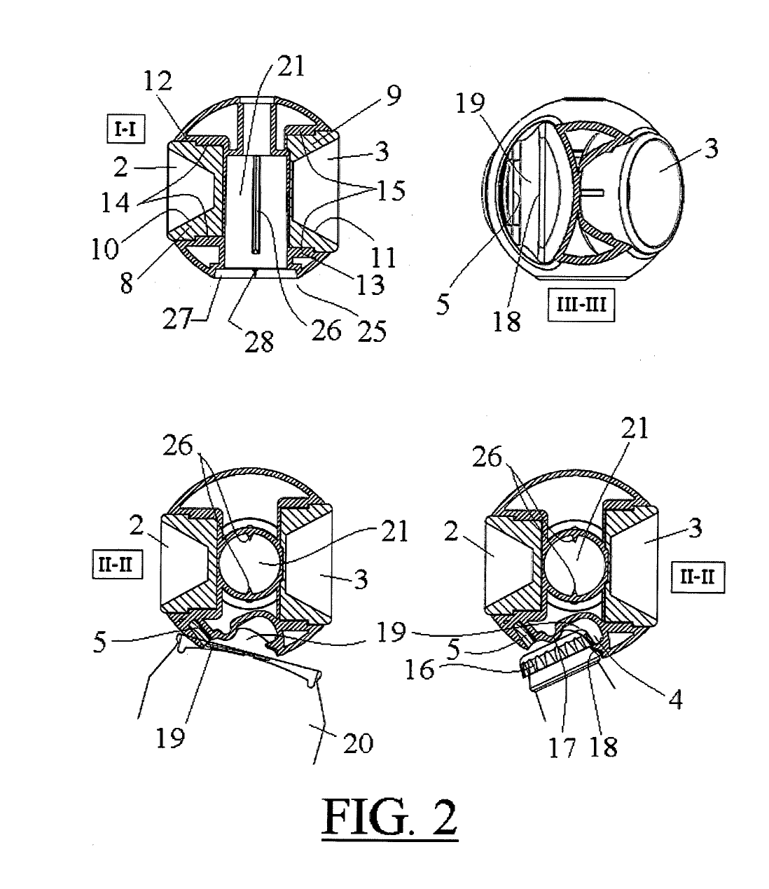

FIG. 2 shows the same preferred embodiment of the base body in a number of cross-sections;

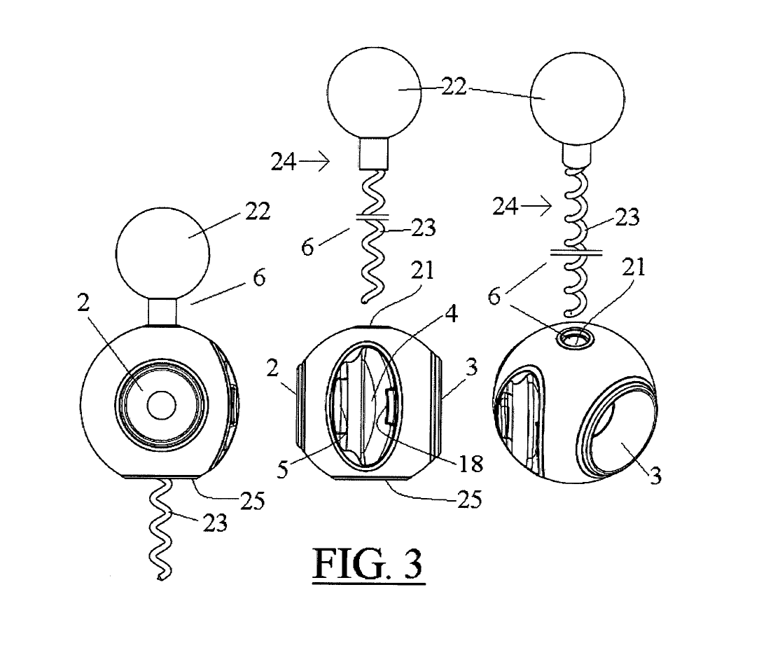

FIG. 3 shows again the same preferred embodiment of the base body in a number of views, including the accompanying screw module;

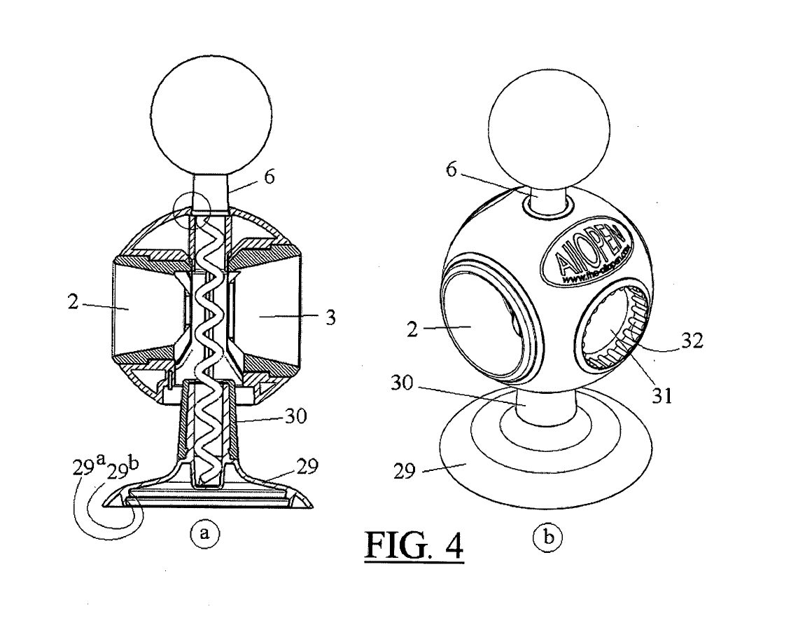

FIG. 4 shows a cross-section and a view of an additional embodiment.

FIGS. 1-3 all show (a part of) a device for opening the closures of different types of containers, particularly of consumer packaging for food and/or stimulants. The device comprises a base body 1 comprising different opener modules 2-6, or a base body that is arranged to comprise and/or receive such different opener modules: in other words, the various opener modules can (partly) be integral with the base body and/or (partly) (as a component) be connected thereto and/or be installed therein. Each opener module 2-6 is intended for and arranged for opening of at least one type of container closure. The enveloping shape of the primary (principal) shape of the exterior side (outside) of the base body 1 is an ellipsoid, spheroid or sphere (spherical shape). The embodiment shown in the FIGS. 1-3 has an enveloping shape of the principal shape of the exterior side of the base body 1, which is illustrated in the 2D-sectional views of FIG. 1 by the enveloping circles 7 (somewhat spacious, widely drawn around the different views).

In the preferred embodiment shown, two opposite opener modules 2 and 3, intended for and arranged for use in opening a screw closure (not shown) by rotation, that is opener modules 2 for the (smaller) screw closures of milk cartons, etc., and opener modules 3 for the (larger) screw closures of PET bottles etc. The opener modules 2 and 3 both comprise a body for rotation 8 and 9 respectively, each having a substantially conical cavity 10 and 11 respectively, each cavity being suitable for engaging with its conical surface the exterior side of the screw closure. The conical cavity is provided with a surface having a high friction resistance, for example, provided with friction-increasing grooves, ribs and/or serrations (not shown) and/or made up of (optionally coated) rubber or elastomer. In the shown preferred embodiment, it is proposed that the bodies for rotation 8 and 9 both entirely are manufactured from a rubber or an elastomer, thereby achieving, partly because of the good elastic properties of the solid bodies for rotation from rubber or elastomer, excellent engagement properties for the screw closures (screw caps). The two bodies for rotation 8 and 9 are received in reception chambers 12 and 13, each provided with anti-rotation ribs 14 and 15 respectively. The opposed positioned conical cavities (funnels) overlap each other in dimensions, thereby being able to open almost all of the common screw caps, without these caps being positioned too deep, which is of particular importance with cartons of milk and fruit juices, wherein the screw cap is placed close to the carton.

An opener module 4 is intended for and arranged for use in opening container closures that operate entirely or partly under the influence of a clamping force, in particular crown cork closures 16. But also for use in exerting a force against the underside of the edge of a screw closure, locked partly under the influence of a clamping force, such as in particular turning lid closures; wherein said clamping force, caused by negative pressure in the container, is largely removed by the aeration of the contents of the container, as a result of pressing (shortly) from the bottom side the closing edge of the screw closure of the turning lid. For both purposes, the top of the container closure—the crown cork closure or the turning lid—is placed against a ridge-shaped protrusion 17, and a more or less sharp projection 18 is pushed from the bottom side against the crown cork closure 16 or the turning lid respectively, by the upward movement of the base 1. Due to the width of the ridge-shaped protrusion 17 either crown corks—with a relatively small diameter—as well as turning lids—with larger diameters—may be actuated, because in all cases during the upward movement of its outer edge by means of the projection 18, the upper surface of the crown cork or turning lid respectively is supported against the (broad) ridge-shaped protrusion 17. Thus respectively, the crown cork 16 is lifted or the content of the container is aerated through the turning lid so that the turning lid can be unscrewed without difficulty. The opener module 4 is housed in a cavity 19, which is arranged on the exterior side of the base body 1.

In the same cavity 19 also an opener module 5 is included which is provided for and arranged for lifting of a pull-tab 19 that is part of the container closure of a beverage can 20. By tilting the (ergonomically shaped) base body 1 and by pulling the pull-tab 19 the can 20 can be easily opened. The opener modules 4 and 5 are consequently arranged in a common cavity 19, provided on the exterior side (outside) of the base body 1.

Finally, the device provides for an opener module 6 which is intended for and arranged for use in opening container closures that are provided with a cork or stopper, in particular wine bottle closures. This opener module comprises a sleeve (shaft, tube) 21 extending through the base body 1, as well as a screw module 24 bearing-mounted against or in the sleeve 21, the screw module being rotatable by means of a handle 22 and being provided with a helical screw element 23. The screw module being further arranged to be able to insert the screw element 23 from one side (the upper side) through the sleeve 21 into the cork or stopper in order to remove (pull, draw) the cork or stopper from the container. The upper edge of the bottle thereby abuts against (and partially within) the bottom side 25 of the sleeve 21. The sleeve 21 on its inside is provided with guide ridges 26 extending in the longitudinal direction of the sleeve 21 for guiding the cork or stopper during its removal from the container. The enveloping shape of the principal shape of the exterior side of the handle 22 of the screw module 24 is also an ellipsoid, spheroid or sphere (ball), which is an advantage for the same reasons as those applicable to the principal shape of the base body 1.

The sleeve 21 is arranged to partly enclose—in a widening 27 in the lower end of the sleeve 21—the end cap of a closure capsule of a wine bottle. The widening 27 is provided with sharp cutting means 28 which are arranged to be pressed into the material of the closure capsule. By means of rotation of the ergonomic base body 1 by the user, and thereby of the enlarged portion 27 of the sleeve 21 and of the cutting means 28 provided therein, the end cap of the closure capsule is cut loose. Subsequently, the cork or stopper is drawn out of the wine bottle by means of rotating by the user of the screw module 24 and the sleeve 21 (including widening 27). The cutting means, for example provided as three flat ground steel pins 28, grind themselves sharp, or they keep themselves sharp, because they scratch over the glass of the top of the wine bottle.

FIG. 4 shows in cross-section and view an additional embodiment. Herein, the “base sphere”, in other words the base body 1, is provided with a corkscrew module 6, further provided with a pedestal 29, in which the tip of the corkscrew is received. The pedestal 29 is further provided with a rubber covering 30, which is inserted in the base body 1 at the bottom of a suitable cavity. Because for this purpose suitable sizes are selected, the rubber covering 30, if detached from the base body 1, may also serve as a closing cork for a wine bottle. On the underside, the pedestal 29 is further provided with concentric elevations 29a and 29b, having such a shape and dimensions that the pedestal 29 can be used as a clamping cover on (for example opened) beverage cans; for both beverage cans of the narrower and the wider (by default) type; the diameters of the concentric elevation 29a and 29b respectively corresponding therewith. The concentric elevation 29a and 29b can then be “clicked” over the upper flange of the bottle concerned.

The embodiment of FIG. 4 further comprises an additional opener module, configured by a cavity 31 in the base body 1 and provided at its inner side with ribs 32 which are suitable for receiving screw-type crown corks, such as for example, those known in the U.S. market.

Finally, the following should be noted:
the helical screw element 23 of the corkscrew module 6 is preferably removable so that the sharp point can be stored separately. The helical screw element 23 and the bodies for rotation 8 and 9 of the opener modules 2 and 3 are replaceable (wear), and also due to possible differences in size of the screw caps in other countries replacement of the bodies for rotation 8 and 9 (the cones) is possible;
the dimensions of the base body are such that the device fits in most common kitchen drawers. In addition, the configuration as shown in FIGS. 1-3, has a further advantage that the (substantially spherical) device does not roll off of the counter, for example, as a result in particular of the two planes which are formed by the bodies for rotation 8 and 9 of the opener modules 2 and 3, arranged in the outer wall of the base body 1.

Accordingly, the present invention provides for a device for opening various container closures, for which different tools are needed or for which as yet no aids were available, and from which especially the elderly and weak will benefit. In particular, and preferably, the device, as already indicated in the foregoing, has a spherical or at least a spherical principle shape; within which shape different opener modules are arranged. Additionally, an opener module, such as the corkscrew module, may be provided although it does not fit within the spherical principle shape. Having a convex principle shape is considered of great importance to the invention, because the exterior shape is ergonomically eminently suitable for the elderly and the (hand) weak.

1. Device, provided for and arranged for opening closures of containers, of consumer packaging for food and/or stimulants, the device comprising:
a base body (1) of a rigid material, comprising an outer wall having an enveloping shape (7) selected from the group consisting of: a ball, ellipsoid, spheroid or sphere; and
one or more opener modules (2, 3, 31) provided in said outer wall of the base body, which are provided and arranged for opening a screw closure by rotation, each one or more module comprising a cavity suitable and arranged for engaging with its side plane (10, 11, 31) an exterior side of the said screw closure.

2. (canceled)

3. Device, according to claim 1, wherein the cavity is provided with a conical surface (10, 11) having a high friction resistance and/or the cavity (31) is provided with grooves (32), ridges, or serrations.

4. Device according to claim 1, wherein the device is provided with an opener module (4) provided for and arranged for opening of container closures, which closures operate at least partly under the influence of a clamping force, such as a module for lifting of container closures that are provided with clamping edges, such as crown cork closures (16), or a module for screw closures secured by means of a clamping force such as turning lid closures.

5. Device according to claim 1, wherein the device is provided with an opener module (5) provided for and arranged for lifting of a pull-tab (19) of a container closure.

6. Device according to claim 1, wherein the device is provided with an opener module intended for and arranged for use as a can opener.

7. Device according to claim 1, whereby two or more opener modules (4, 5) are arranged in a common cavity (19) on the exterior side of the base body (1).

8. Device according to claim 1, wherein the device is provided with an opener module (6) provided for and arranged for opening container closures that are provided with a cork or stopper.

9. Device according to claim 8, wherein the opener module (6), for opening of container closures that are provided with a cork or stopper, comprises a sleeve (21) extending through the base body (1), a screw module (24) bearing-mounted against or in the sleeve, the screw module being rotatable by means of a handle (22) and being provided with a helical screw element (23), the screw module being arranged to insert the screw element from one side through the sleeve into the cork or stopper, in order to remove the cork or stopper from the container closures.

10. Device according to claim 9, wherein the sleeve (21) on its interior side is provided with one or more guide ridges (26) that extend in the longitudinal direction of the sleeve for guiding of the cork or the stopper during its movement out of the container.

11. Device according to claim 9, wherein the enveloping shape of the principal shape of the exterior side of the handle (22) of the screw module is selected from the group consisting of: a ball, ellipsoid, spheroid or sphere.

12. Device according to claims 9, wherein the sleeve is arranged to partly enclose—at least with one end (25)—an end cap of a closure capsule of a bottle, and wherein the sleeve at the end is provided with means (28) for cutting loose, by rotation of the sleeve (21) and/or the base body (1), the end cap of the closure capsule, before the cork or stopper is moved out of the container.
